(19) United States
(12) Patent Application Publication
(10) Pub. No.: US 2025/0353761 A1
(43) Pub. Date: Nov. 20, 2025

(54) Methods and Systems for Ion Separation and Recovery

(71) Applicant: Triangle Environmental Health Initiative, LLC, Durham, NC (US)

(72) Inventor: Marielle DuToit, Durham, NC (US)

(73) Assignee: Triangle Environmental Health Initiative, LLC, Durham, NC (US)

(21) Appl. No.: 19/208,165

(22) Filed: May 14, 2025

Related U.S. Application Data
(60) Provisional application No. 63/647,412, filed on May 14, 2024.

(51) Int. Cl. C02F 1/469; B01D 61/46; B01D 61/50; B01D 65/08; C02F 101/10; C02F 101/16; C02F 101/20

(52) U.S. Cl. CPC C02F 1/4693; B01D 61/462; B01D 61/463; B01D 61/465; B01D 61/50; B01D 65/08; B01D 2321/22; C02F 2101/105; C02F 2101/16; C02F 2101/20; C02F 2301/046

(57) ABSTRACT

The present disclosure describes an electrochemical system and methods for the selective separation and simultaneous recovery of ionic constituents in a feed-, raw-, or wastewater. The system entails novel electrochemical configurations comprising various ion exchange membranes in concert with a voltage applied across a pair of electrodes. In some embodiments, the novel electrochemical system may include one or more of a pair of electrodes, a first membrane selectively permeable to a first wastewater constituent, a second membrane selectively permeable to a second wastewater constituent, a third membrane selectively permeable to a third wastewater constituent, a fourth membrane impermeable to ions that allows for the separation of a fourth constituent by preventing mixing between first and third product channels when a plurality of membrane stacks are utilized, and at least four spacing frames comprising a structural element, a gasket, and a flow channel.

### CROSS-REFERENCE TO RELATED APPLICATION(S)

This application claims the benefit of U.S. Provisional Application No. 63/647,412, filed May 14, 2024.

The contents of each of the above referenced applications are hereby incorporated by reference in their entirety.

### TECHNICAL FIELD

Various aspects of the present disclosure relate generally to systems and methods for ion separation and recovery.

### BACKGROUND

Water pollution is a global crisis, with severe implications for human health, environmental sustainability, and economic prosperity. According to the World Health Organization (WHO), approximately 80% of global wastewater flows back into ecosystems without adequate treatment, leading to the contamination of water sources and posing significant risks to public health. Industrial activities, urbanization, and agricultural runoff contribute to the proliferation of pollutants such as heavy metals, organic chemicals, and pathogens in both raw and wastewater streams. These hazards not only threaten aquatic ecosystems but also compromise the availability of safe drinking water for communities worldwide.

Furthermore, the scarcity of freshwater resources exacerbates the urgency of addressing water pollution. The United Nations estimates that by 2050, global water demand will increase by 35%, primarily driven by population growth, urbanization, and industrialization. This surge in demand amplifies the strain on existing water sources, heightening the need for sustainable water management solutions. Moreover, the growing depletion of finite resources, such as phosphorus and nitrogen, underscores the imperative for technologies that are capable of recovering valuable constituents while treating water.

Traditional wastewater treatment methods often focus solely on pollutant removal, overlooking the potential for resource recovery. Conventional approaches, such as biological treatment and physical-chemical separation processes, are effective but typically require significant energy inputs and generate secondary waste streams. Moreover, existing techniques often lack the requisite selectivity to efficiently target specific pollutants while preserving valuable resources.

In light of these challenges, there is a critical need for innovative water treatment technologies that not only purify water but also facilitate the recovery of valuable resources in a selective manner. Achieving high selectivity for both desirable and undesirable constituents is paramount for maximizing the efficiency and sustainability of water treatment processes. This requires a paradigm shift towards integrated approaches that harness advanced techniques such as electrochemical methods, which can offer precise control over the removal and recovery of target species from complex water matrices.

The present disclosure is directed to overcoming one or more of these above-referenced challenges.

### SUMMARY OF THE DISCLOSURE

According to certain aspects of the disclosure, systems, methods, and computer readable memory are disclosed for ion separation and recovery.

In some cases, a method for treating feed-, raw-, or wastewater, or other aqueous streams (“streams”) for select constituents while simultaneously recovering select desirable constituents from the streams may include: (i) providing a selective ion separation system (SISR) comprising a pair of electrodes, a catholyte compartment containing the cathode and aqueous electrolyte, an anolyte compartment containing the anode and aqueous electrolyte, and one or more multi-compartment cell “quartets,” in which each of the cell quartets includes: a first membrane (selective cation exchange membrane that is selective to all monovalent cations or specific cations), the first membrane being impermeable to a first aqueous ion and selectively permeable to a second aqueous ion, a second membrane (nonselective anion exchange membrane), the second membrane being selectively permeable to a third aqueous ion, a third membrane (selective anion exchange membrane that is selective to all monovalent anions or specific anions), the third membrane being selectively permeable to a fourth aqueous ion, a fourth membrane (bipolar ion exchange membrane), the fourth membrane being impermeable to ions in order to maintain a barrier between repeating units of membranes 1-3 when repeating units of the membrane quartets are utilized, at least four spacing frames, where each spacing frame comprises a structural element, a gasket, and a flow channel, wherein the membrane cell quartets are positioned between the catholyte and anolyte compartments, and the catholyte and anolyte compartments are each separated from the membrane quartet by means of a spacing frame and permselective cation exchange membrane; (ii) applying a voltage across said cathode and anode to transport select ions through compatible ion exchange membranes while flowing a feed-, raw-, or wastewater containing select undesirable constituents for treatment and/or select desirable constituents for recovery through the SISR system; (iii) using the membrane cell quartets and the applied voltage to produce at least four concentrated output streams, wherein each output stream comprises a higher level of the first aqueous ion, the second aqueous ion, the third aqueous ion, and the fourth first aqueous ion compared to the feed, raw, or wastewater.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 depicts a system for ion separation and recovery.

FIG. 2 illustrates a flowchart for a method of ion separation and recovery, according to aspects of the present disclosure.

FIG. 3 illustrates a flowchart for a method of operating a selective ion separation and recovery system, according to an embodiment.

FIG. 4 depicts an example system that may execute techniques presented herein.

### DETAILED DESCRIPTION

Various aspects of the present disclosure relate generally to ion separation and recovery.

The proposed device represents a significant technological advancement by leveraging electrochemical principles for simultaneous water treatment and resource recovery. By integrating highly selective ion exchange membranes with advanced separation techniques, the device can effectively separate specific contaminants while recovering valuable constituents from various feed-, raw-, or wastewaters. This novel approach not only addresses the pressing need for sustainable water management solutions but also contributes to the transition towards a circular economy by transforming wastewater into a valuable resource.

The present disclosure provides a method for the selective separation of specific ions from feed-, raw-, or wastewater, or other aqueous streams, allowing for simultaneous water treatment and resource recovery. The proposed system offers superior selectivity compared to existing electrochemical techniques and separation processes, which is achieved through novel configurations of ion exchange membranes paired with an applied voltage in a modified electrodialysis setup.

In an aspect, the presented selective ion separation and recovery system (SISR) comprises: a pair of electrodes; compartments containing electrolyte that house the electrodes; one or more multi-compartment cells (henceforth deemed “quartets”); and a housing. Each of the cell quartets includes at least four compartments for various SISR separation products. The compartments are separated by at least four different permselective ion exchange membranes, wherein said membranes include: a first membrane impermeable to a first constituent and selectively permeable to a second constituent, a second membrane selectively permeable to a third constituent, a third membrane selectively permeable to a fourth constituent, a fourth membrane impermeable to constituents that prevents mixing between the first and fourth product channels when a plurality of membrane quartets are utilized. The SISR product compartments are constituted by at least four spacing frames, which comprise a structural element, a gasket, and a flow channel. The one or more membrane quartet units are positioned between the pair of electrodes.

In an aspect, the method for selective separation comprises pumping feed-, raw-, or wastewater, or other aqueous streams into the SISR system; applying a voltage to the pair of electrodes; and producing at least four output streams, wherein each output stream comprises a higher level of the first, second, third, and/or fourth select constituent compared to the feed water or other aqueous streams.

In some embodiments, the method further comprises removing foulant from the SISR system. In some embodiments, removing the foulant from the SISR system comprises switching polarity of the voltage. In some embodiments, switching polarity of the voltage comprises repeatedly applying a forward bias voltage and then applying a reverse bias voltage. In some embodiments, the forward bias voltage is applied from 0.1 hours to 4 hours, then the reverse bias voltage is applied for from 0.1 minutes to 30 minutes. In some embodiments, a loss of performance of the first, second, or third membrane is less than 60%. In some embodiments, the applied voltage is in the range of from 10 VDC to 100 VDC. In some embodiments, the applied voltage is in the range of from 20 VDC to 30 VDC.

In some embodiments, the method further comprises prioritizing SISR system efficiency and productivity by flowing feed-, raw-, or wastewater or other aqueous streams into the SISR system in a single, continuous flow-through pass. In some embodiments, the method further comprises increasing SISR system product concentration capacity by flowing feed-, raw-, or wastewater, or other aqueous streams into the SISR system in a batch process, wherein the at least four SISR separation products are returned to the at least four influent channels in recycle loop, and wherein the recycle loop is performed until the desired constituent concentration is reached.

In some embodiments, the method further comprises detecting changes in the system using a sensor and/or using a sensor to instruct a controller to change operating parameters of the SISR system. In some embodiments, the method further comprises collecting one or more of the output streams for constituent recovery, reuse, and/or discharge. In some embodiments, the at least four output streams comprise concentrate streams enriched in each of four types of constituents, including monovalent cations, multivalent cations, multivalent anions, and monovalent anions.

In some embodiments, the first membrane is a monovalent-selective cation exchange membrane or ion-specific cation exchange membrane. In some embodiments, the second membrane is an anion exchange membrane. In some embodiments, the third membrane is a monovalent-selection anion exchange membrane or ion-specific anion exchange membrane. In some embodiments, the fourth membrane is a bipolar ion exchange membrane. In some embodiments, the first feed-, raw-, or wastewater constituent comprises multivalent cations. In some embodiments, the second feed-, raw-, or wastewater constituent comprises monovalent cations. In some embodiments, the third feed-, raw-, or wastewater constituent comprises multivalent anions. In some embodiments, the fourth feed-, raw-, or wastewater constituent comprises monovalent anions.

In some embodiments, the feed-, raw-, or wastewater, is directed to the entry port of the second SISR quartet compartment between the monovalent cation exchange membrane and the anion exchange membrane, while fresh tap water is directed to the entry ports of the first, third, and fourth SISR quartet compartments in order to provide clean streams for ion migration and sequestration from the feed, raw, or wastewater. In some embodiments, feed-, raw-, or wastewater are flown through the SISR system in one single continuous pass. In some embodiments, the at least four products emerging from the SISR system are recirculated in a closed loop such that the at least four separate product streams are returned to the respective entry ports of the at least for compartments to further concentrate the respective SISR product ions.

In some embodiments, the concentration of select multivalent cations in the first output stream is more than 400%, more than 300% more than 200%, more than 100%, 80%, more than 70%, 60%, more than 50%, more than 40%, more than 30%, more than 20%, more than 15%, more than 10%, or more than 5% of the select monovalent cation concentration in the feed-, raw-, or wastewater. In some embodiments, the concentration of select monovalent cations in the second output stream is more than 400%, more than 300% more than 200%, more than 100%, more than more than 80%, more than 70%, 60%, more than 50%, more than 40%, more than 30%, more than 20%, more than 15%, more than 10%, or more than 5% of the select multivalent cation concentration in the feed-, raw-, or wastewater. In some embodiments, the concentration of select multivalent anions in the third output stream is more than 400%, more than 300% more than 200%, more than 100%, 80%, more than 70%, more than 60%, more than 50%, more than 40%, more than 30%, more than 20%, more than 15%, more than 10%, or more than 5% of the select multivalent anion concentration in the feed-, raw-, or wastewater. In some embodiments, the concentration of select monovalent anions in the fourth output stream is more than 400%, more than 300% more than 200%, more than 100%, 80%, more than 70%, more than 60%, more than 50%, more than 40%, more than 30%, more than 20%, more than 15%, more than 10%, or more than 5% of the select monovalent anion concentration in the feed-, raw-, or wastewater.

In some embodiments, the spacing frame comprises at least four inlet openings and at least four outlet openings. In some embodiments, the SISR channel unit comprises four spacing frames, wherein the spacing frames produce four concentrated product streams. In some embodiments, the spacing frame comprises a planar flow area with a length from 5 cm to 100 cm and a width from 5 cm to 100 cm. In some embodiments, the system further comprises one or more end channels with electrolyte solution. In some embodiments, the system further comprises a power supply configured to apply a cyclically reversed voltage. In some embodiments, the system further comprises a controller and at least one sensor configured to detect changes in the system, wherein the sensor is optionally one of a conductivity, ion, current, visual, and acoustic sensor. In some embodiments, the system comprises a plurality of SISR units configured to operate in series or in parallel or a combination of the two.

One aspect of the present disclosure provides a selective ion separation and recovery (SISR) channel unit, the channel unit comprising, consisting of, or consisting essentially of a monovalent-selective cation exchange membrane or ion-specific cation exchange membrane, an anion exchange membrane, a monovalent-selective anion exchange membrane or ion-specific anion exchange membrane, a bipolar ion exchange membrane, and at least four spacing frame comprising a structural element, a gasket, and a flow channel, where the channel unit is configured to remove monovalent cations, multivalent cations, multivalent anions, and monovalent anions from [feed, raw, or waste] water or other aqueous solutions through electrodialysis.

Another aspect of the present disclosure provides a selective ion separation and recovery (SISR) cell stack, termed a “quartet”, comprising, consisting of, or consisting essentially of four or more channel units according to the disclosure herein, a pair of electrodes at each end of the membrane quartets, and an end channel with electrolyte solution. In some embodiments, the SISR cell stack comprises 1 to 50, e.g., 3 to 50, 5 to 15, 10 to 20, 15 to 25, 20 to 30, 25 to 35, 30 to 40, 35 to 45, or 40 to 50 membrane quartets.

Another aspect of the present disclosure provides a selective ion separation and recovery (SISR) system, comprising, consisting of, or consisting essentially of at least one SISR cell stack and a power supply configured to apply a cyclically reversed voltage.

In some embodiments, a SISR system comprises a controller and at least one sensor configured to detect changes in the system, wherein the sensor is optionally one of a conductivity, ion, current, visual, and acoustic sensor.

In some embodiments, a SISR system comprises a plurality of SISR cell stacks configured to operate in series or in parallel or a combination of the two.

Another aspect of the present disclosure provides all that is described and illustrated herein.

Thus, methods and systems of the present disclosure may be improvements to treatment of feed-, raw-, or wastewater, and ion separation and recovery systems.

### 1. ION SEPARATION AND RECOVERY SYSTEM

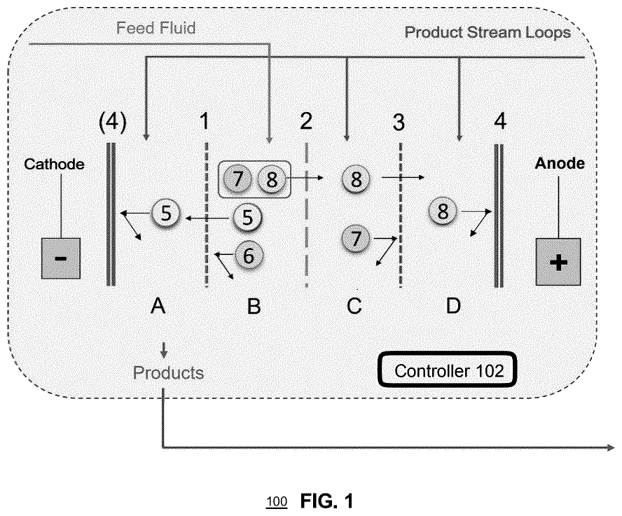

FIG. 1 shows an ion separation and recovery system 100 (“SISR system 100”).

The system 100 includes a number of distinct charge and valence selective ion-separating membranes, labeled 1, 2, 3, and 4, which are separated by spacing frames. Each spacing frame constitutes an electrodialytic channel, labeled A, B, C, and D, which receives a feed fluid stream to be treated or clean water, and which each produces a product stream at least partially concentrated with select ionic constituents 5, 6, 7, and 8, respectively. This unique arrangement of membranes 1, 2, 3, 4, and spacing frames is termed a “membrane quartet,” which may be installed in one or more repeating units in the SISR system 100. One or more membrane quartets are placed between a cathode chamber, containing a cathode and catholyte solution, and an anode chamber, containing an anode and anolyte solution, in a housing.

In all configurations, a voltage is applied across the cathode and anode to drive ionic constituents across complementary ion-separating membranes into their respective channels. In the configuration shown in FIG. 1, the SISR process begins by flowing feed fluid into channel B while clean water is initially fed into channels A, C, and D. This starting condition allows ionic constituents 5, 7, and 8, to be extracted from the feed fluid and drawn into clean channels A, C, and D to produce product streams that are exclusively enriched with the constituents of interest. Meanwhile, channel B is at least partially depleted of ionic constituents 5, 7, and 8, which produces a concentrate stream enriched with constituent 6 that may also contain a fraction of other components that do not get removed from the feed fluid during electrodialytic transport. Within each electrodialytic channel A, B, C, and D, membranes 1, 2, 3, and 4 are arranged with respect to each other as well as the position of the cathode and anode to enable the selective separation of ionic constituents.

The SISR system 100 configuration depicted in FIG. 1, with one or more repeating membrane quartets, may be operated in continuous or batch processes. For the continuous process, feed fluid and clean water are continuously delivered to their respective channels, and product streams at least partially enriched with ionic constituents 5, 6, 7, and 8 are continually produced from channels A, B, C, and D in a single fluidic pass. For the batch processes, feed fluid may be initially or continuously delivered to channel B, and clean water is only initially delivered to channels A, C, and D. Ionic products from each channel are then recycled back to channel entry ports and recirculated for a period of time to increase the concentration of select constituents in each channel. Recirculation may be performed until desired product stream concentrations are reached. During the recirculation period, new feed fluid may be continuously added to channel B for treatment, or channel B products may be recirculated alone to achieve further constituent separation. Batch processes may be conducted in consecutive execution to maximize feed fluid treatment as well as product stream concentration.

### 2. TESTING

### 2.A. Polarity Reversal

The following examples provide results and information from lab testing with a simplified electrodialysis (ED) system that does not include all of the features of the SISR system 100. However, these results provide confirmation of some key concepts behind the SISR system 100.

Polarity reversal, wherein the voltage applied between the anode and cathode is switched periodically, was investigated as a method to prevent or reverse membrane fouling during electrodialysis. Two experiments were performed, each lasting ˜170 h (˜7 days). In the first experiment, polarity reversal was performed only up to 27 h; in the second experiment, polarity reversal was performed every 2 h for the duration of the 7-day-long experiment. Results showed that the concentration of NO3- in the diluate stream gradually increased over time, indicating a loss in performance without polarity reversal.

In contrast, no performance loss was observed when polarity reversals were applied regularly throughout Experiment 2. The concentration of NO3- in the diluate remained low (˜10 mg/L) throughout the 7-day-long duration of the experiment. NO3- concentrations in the diluate from non-reversal experiments showed a 20-60% increase over time (4-6 hours).

The results confirmed that polarity reversal is an effective strategy for preventing performance loss due to membrane fouling. These experiments further indicated that polarity reversal is highly beneficial when incorporated into the regular operating conditions of the ED system.

These polarity reversal techniques have since been incorporated into SISR testing protocols to mitigate membrane fouling and extend membrane lifespan. In current testing, polarity is reversed for a minimum of 2 minutes following each hour of operation. To date, data from these ongoing SISR experiments have not yet shown any observable decline in performance, aligning with earlier findings from the simple ED system. This consistency across systems reinforces the value of polarity reversal as a practical and effective operational strategy to maintain long-term electrodialytic performance and membrane integrity.

2.B. Preliminary SISR Testing with Synthetic Wastewater Solution

The SISR system was initially evaluated using a scaled-down configuration with limited membrane surface area to demonstrate the proof of concept using a synthetic wastewater solution. While these early tests provided valuable insights into ion separation trends, they do not reflect the full transport capacity of the system, which increases with greater membrane area. Preliminary testing employed three membrane quartets, compared to the six to ten quartets anticipated for full-scale implementation and optimal performance at the given flow rates (10 mL/min per product channel). A voltage of 2 V per cell pair was applied, yielding a total of 6 V across the test setup.

A series of one-hour batch experiments were conducted using synthetic wastewater containing a mixture of salts. The solution included 50 mg/L of NH4 (1+), 15 mg/L of H2PO4 (1−), 15 mg/L of Ca (2+), 20 mg/L of Mg (2+), 0.05 mg/L of Cu (2+), and 0.15 mg/L of Zn (2+). Results from these experiments indicated effective ion partitioning: NH4 accumulated in the 1+product stream at rates of 75-95%, H2PO4 in the 1-stream at 20-41%, Ca and Mg in the N+ stream between 50-54% and 36-42%, respectively, and Cu and Zn (as Cu(OH)2 and Zn(OH)2, which have 2-charge) in N-stream between 80-90% and 52-56%, respectively.

### 3. FLOWCHARTS

The selective ion separation and recovery (SISR) system provides a novel approach to water treatment and resource recovery. This system may address challenges in wastewater management by selectively separating and recovering specific ionic constituents from feed-, raw-, or wastewater streams. The SISR system may offer advantages in terms of efficiency, selectivity, and resource recovery compared to conventional water treatment methods.

In some cases, the SISR system may be utilized as a pre-treatment step for downstream water treatment operations. This pre-treatment application may enhance the overall efficiency of water treatment processes by selectively removing or concentrating certain ionic species before further processing.

The SISR system may be configured with varying numbers of membrane quartets to accommodate different treatment capacities and requirements. In some cases, the system may comprise from 1 to 50 membrane quartets. This scalability may allow for flexibility in system design and adaptation to various treatment scenarios.

For larger-scale applications or complex treatment requirements, multiple SISR units may be employed. In some cases, a plurality of SISR units may be configured to operate in series, in parallel, or in a combination of series and parallel arrangements. This modular approach may allow for customized treatment solutions and may provide opportunities for process optimization based on specific water quality goals and operational constraints.

FIG. 1 shows a selective ion separation and recovery (SISR) system 100. The SISR system 100 may comprise a pair of electrodes, including a cathode in a catholyte compartment and an anode in an anolyte compartment. Between these electrode compartments, the SISR system 100 may include one or more multi-compartment cell “quartets”.

Each cell quartet may comprise four distinct ion-separating membranes: a monovalent selective cation membrane 1, an anion exchange membrane 2, a monovalent selective anion membrane 3, and a bipolar membrane 4. In some cases, the monovalent selective cation membrane 1 may be an ion-specific cation exchange membrane. Similarly, the monovalent selective anion membrane 3 may be an ion-specific anion exchange membrane in some implementations.

The membranes in each quartet may be separated by spacing frames, which form electrodialytic channels labeled A, B, C, and D. Each spacing frame may comprise a structural element, a gasket, and a flow channel. In some cases, the spacing frame may comprise a planar flow area with a length from 5 cm to 100 cm and a width from 5 cm to 100 cm. The spacing frame may include at least four inlet openings and at least four outlet openings.

When voltage is applied across the electrodes, the SISR system 100 may produce four distinct concentrated output streams. A monovalent cation stream 5 may flow through channel A, a multivalent cation stream 6 may flow through channel B, a multivalent anion stream 7 may flow through channel C, and a monovalent anion stream 8 may flow through channel D.

In operation, feed fluid may enter channel B while clean water initially flows through channels A, C, and D. The applied voltage may drive ionic constituents across complementary ion-separating membranes into their respective channels. The monovalent selective cation membrane 1 may allow selective passage of certain ions while blocking others. The anion exchange membrane 2 may permit selective transport of specific anions. The monovalent selective anion membrane 3 may enable selective passage of monovalent anions. The bipolar membrane 4 may maintain separation between repeating membrane units when multiple quartets are used.

The SISR system 100 may include a power supply configured to apply a cyclically reversed voltage. In some cases, the applied voltage may be in the range of from 10 VDC to 100 VDC. The system may also comprise one or more end channels with electrolyte solution.

For monitoring and control purposes, the SISR system 100 may include a controller 102 and at least one sensor configured to detect changes in the system. The sensor may be one of a conductivity, ion, current, visual, and acoustic sensor.

This arrangement of membranes and channels in the SISR system 100 may allow for selective separation of different types of ions from the feed fluid, producing concentrated streams of monovalent cations, multivalent cations, multivalent anions, and monovalent anions.

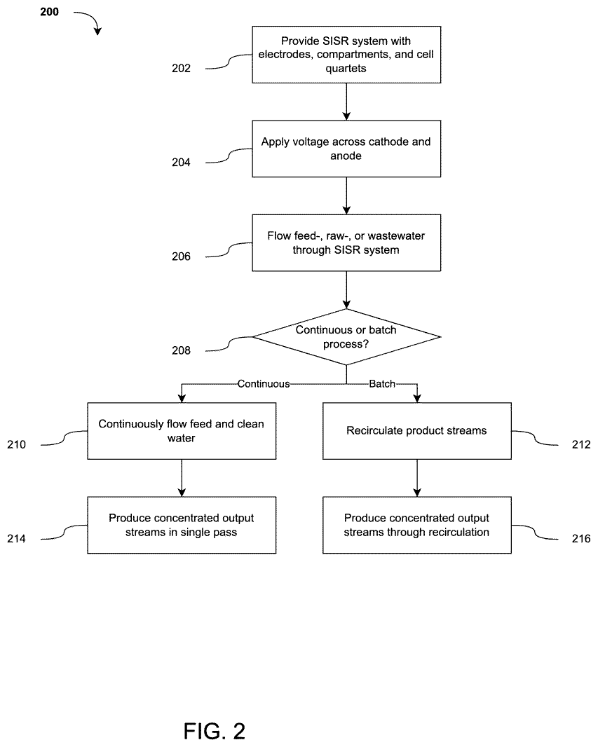

FIG. 2 illustrates a method 200 for ion separation and recovery using the selective ion separation and recovery (SISR) system. The method 200 may comprise several steps for treating feed-, raw-, or wastewater streams while simultaneously recovering select desirable constituents.

The method 200 may begin with a step 202 of providing a SISR system. In some cases, the SISR system may comprise a pair of electrodes, compartments containing electrolyte that house the electrodes, and one or more multi-compartment cell quartets. Each cell quartet may include the monovalent selective cation membrane, the anion exchange membrane, the monovalent selective anion membrane, and the bipolar membrane.

In a step 204, voltage may be applied across the cathode and anode of the SISR system. This applied voltage may drive the transport of select ions through compatible ion exchange membranes. The voltage application may enable the selective separation of ionic constituents based on their charge and valence.

A step 206 may involve flowing feed-, raw-, or wastewater through the SISR system. In some cases, the feed-, raw-, or wastewater may contain monovalent cations, multivalent cations, multivalent anions, and monovalent anions. The flow of this water through the system may allow for the treatment of undesirable constituents and the recovery of desirable constituents.

The method 200 may then proceed to a decision point in step 208, where the process determines whether to operate in continuous or batch mode. This decision may affect the subsequent steps and the overall efficiency of the ion separation and recovery process.

If continuous operation is selected, the method 200 may proceed to a step 210. In this step, feed and clean water may be continuously flowed through the system. This continuous, single flow-through pass may prioritize efficiency and productivity of the SISR system. The method 200 may then move to a step 214, where concentrated output streams may be produced in a single pass.

Alternatively, if batch operation is selected at the decision point in step 208, the method 200 may follow a different path to a step 212. In this step, product streams may be recirculated. This batch process with a recycle loop may increase the product concentration capacity of the SISR system. The method 200 may then proceed to a step 216, where concentrated output streams may be produced through recirculation.

In both operational modes, the method 200 may produce at least four concentrated output streams. These may include the monovalent cation stream, the multivalent cation stream, the multivalent anion stream, and the monovalent anion stream. Each of these output streams may comprise a higher level of specific ionic constituents compared to the feed-, raw-, or wastewater.

In some cases, the method 200 may achieve specific concentration levels of monovalent cations in the first output stream. For example, the concentration of monovalent cations in this stream may be significantly higher than in the original feed-, raw-, or wastewater.

The method 200 may also include collecting one or more of the output streams for constituent recovery, reuse, and/or discharge. This step may allow for the efficient utilization of the separated and concentrated ionic constituents, contributing to resource recovery and sustainable water management practices.

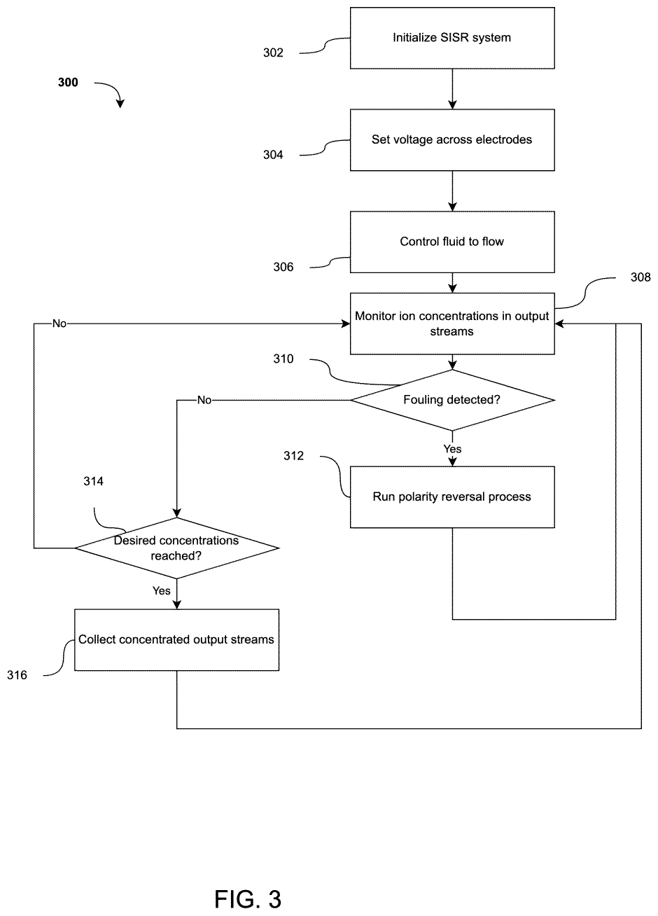

FIG. 3 illustrates a method 300 for operating the selective ion separation and recovery (SISR) system. The method 300 may comprise several steps for initializing, monitoring, and maintaining the SISR system to ensure efficient ion separation and recovery.

The method 300 may begin with a step 302 of initializing the SISR system. This initialization step may involve preparing the system components, including the monovalent selective cation membrane, the anion exchange membrane, the monovalent selective anion membrane, and the bipolar membrane.

In a step 304, voltage may be set across the electrodes in the SISR system. This voltage application may enable the selective transport of ions through the membranes.

A step 306 may involve controlling fluid flow through the SISR system. This step may include regulating the flow of feed-, raw-, or wastewater through the system to ensure optimal ion separation.

The method 300 may then proceed to a step 308 of monitoring ion concentrations in the output streams. This monitoring may include tracking the concentrations in the monovalent cation stream, the multivalent cation stream, the multivalent anion stream, and the monovalent anion stream.

Following the monitoring step, the method 300 may reach a decision point in step 310 where fouling detection may be evaluated. If fouling may be detected, the method 300 may proceed to a step 312 where a polarity reversal process may be run.

In some cases, the polarity reversal process in step 312 may involve switching the polarity of the voltage applied to the SISR system. This polarity reversal may help remove foulant from the system. The method may apply forward and reverse bias voltages for specific durations to remove foulant. For example, a forward bias voltage may be applied for a duration ranging from 0.1 hours to 4 hours, followed by a reverse bias voltage applied for a duration ranging from 0.1 minutes to 30 minutes.

If fouling may not be detected in step 310, or after completing the polarity reversal process in step 312, the method 300 may proceed to another decision point in step 314. This step may involve checking if desired concentrations have been reached in the output streams.

If the desired concentrations have not been reached, the method 300 may return to step 308 to continue monitoring ion concentrations. This feedback loop may ensure that the SISR system continues to operate until the target ion separation may be achieved.

If the desired concentrations have been reached, the method 300 may proceed to a step 316 where concentrated output streams may be collected. These collected streams may be used for constituent recovery, reuse, or discharge.

After the collection step, the method 300 may return to step 308 to continue monitoring ion concentrations, maintaining a continuous operational cycle.

In some cases, the method 300 may include additional steps for mitigating foulant accumulation. This mitigation may involve pulsing the applied voltage across the electrodes. The pulsing process may comprise repeatedly applying a forward bias voltage followed by a period of zero voltage. For example, the forward bias voltage may be applied for a duration ranging from 0.1 seconds to 5 minutes, followed by a zero voltage period for a duration also ranging from 0.1 seconds to 5 minutes.

The method 300 may also enable energy recovery during the zero voltage condition. In some cases, this energy recovery may be achieved by utilizing the bipolar membrane. The SISR system may generate a voltage by passing an acidic solution on one side of the bipolar membrane and a basic solution on the opposite side.

By implementing these operational steps and fouling mitigation strategies, the method 300 may maintain ion separation performance of the membranes over time. In some cases, with routine application of these fouling mitigation techniques, the ion separation performance of the monovalent selective cation membrane, the anion exchange membrane, or the monovalent selective anion membrane may not decrease by more than 60% after six months of use.

The selective ion separation and recovery (SISR) system integrates various components and methods to perform efficient ion separation and recovery from feed-, raw-, or wastewater streams. The system may comprise multiple elements working in concert to achieve selective separation of ionic constituents.

In some cases, the SISR system may include a pair of electrodes, compartments containing electrolyte that house the electrodes, and one or more multi-compartment cell quartets. Each cell quartet may contain four distinct ion-separating membranes: a monovalent-selective cation exchange membrane, an anion exchange membrane, a monovalent-selective anion exchange membrane, and a bipolar membrane. These membranes may be separated by spacing frames, which form electrodialytic channels.

The overall process of ion separation and recovery may begin with the application of voltage across the electrodes. This applied voltage may drive the transport of select ions through compatible ion exchange membranes. The feed-, raw-, or wastewater may then be introduced into the system, flowing through the electrodialytic channels.

As illustrated in FIG. 1, the SISR system may produce four distinct concentrated output streams. These streams may include a monovalent cation stream, a multivalent cation stream, a multivalent anion stream, and a monovalent anion stream. Each output stream may comprise a higher level of specific ionic constituents compared to the feed-, raw-, or wastewater.

The method of operating the SISR system, as depicted in FIG. 2, may involve several steps. The process may begin with the initialization of the system, followed by the application of voltage and control of fluid flow. The system may then monitor ion concentrations in the output streams.

In some cases, the SISR system may employ fouling mitigation strategies to maintain long-term performance. As shown in FIG. 3, the system may detect fouling and initiate a polarity reversal process. This process may involve switching the polarity of the applied voltage to remove foulant from the system.

The SISR system may operate in either continuous or batch mode. In continuous mode, feed and clean water may be continuously flowed through the system, producing concentrated output streams in a single pass. In batch mode, product streams may be recirculated to increase product concentration capacity.

In some cases, the SISR system may include additional features for energy recovery and system monitoring. The system may generate voltage during zero voltage conditions by utilizing the bipolar membrane. Additionally, sensors may be employed to detect changes in the system and adjust operating parameters as needed.

The integration of these components and methods may allow the SISR system to achieve selective separation of different types of ions from feed-, raw-, or wastewater streams. This selective separation may enable efficient treatment of undesirable constituents while simultaneously recovering valuable resources.

In some aspects, the controller 102 of the SISR system 100 may manage and coordinate various operations of the system. The controller 102 may be implemented as a microprocessor, microcontroller, programmable logic controller (PLC), or other suitable computing device.

The controller 102 may be communicatively coupled to various components of the SISR system 100, including the electrodes, pumps, valves, and sensors. This connectivity may allow the controller 102 to monitor system parameters and adjust operating conditions in real-time.

In some implementations, the controller 102 may regulate the voltage applied across the electrodes. The controller 102 may adjust the voltage magnitude, polarity, and duration based on factors such as feed water composition, desired output concentrations, and system performance metrics. For example, the controller 102 may initiate and manage the polarity reversal process to mitigate membrane fouling.

The controller 102 may also manage fluid flow through the SISR system 100. This may involve controlling pumps and valves to regulate the flow rates of feed water, clean water, and recirculated streams. The controller 102 may adjust these flow rates based on the selected operational mode (continuous or batch) and the current state of the separation process.

In some cases, the controller 102 may interface with various sensors throughout the SISR system 100. These sensors may provide data on parameters such as ion concentrations, PH levels, temperature, and pressure. The controller 102 may use this sensor data to monitor system performance, detect fouling conditions, and make real-time adjustments to maintain optimal separation efficiency.

The controller 102 may implement control algorithms and decision-making logic to optimize the SISR process. For instance, it may determine when to switch between continuous and batch modes, when to initiate polarity reversal, or when to adjust voltage levels based on changing feed water conditions or separation targets.

In some implementations, the controller 102 may include a user interface that allows operators to input process parameters, monitor system status, and receive alerts or notifications. The controller 102 may also log operational data for later analysis and process optimization.

The controller 102 may be programmed to implement energy-saving strategies, such as managing the energy recovery process during zero voltage conditions. It may coordinate the flow of acidic and basic solutions across the bipolar membrane to generate voltage when appropriate.

In some aspects, the controller 102 may be capable of adaptive control, using machine learning algorithms to optimize system performance over time based on historical operational data and changing input conditions. This adaptive capability may allow the SISR system 100 to maintain high efficiency across a wide range of feed water compositions and separation requirements.

### 4. COMPUTER SYSTEM

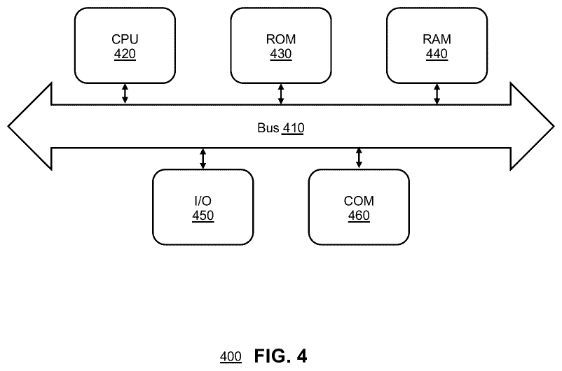

FIG. 4 depicts an example system that may execute techniques presented herein. FIG. 4 is a simplified functional block diagram of a computer that may be configured to execute techniques described herein, according to exemplary cases of the present disclosure. Specifically, the computer (or “platform” as it may not be a single physical computer infrastructure) may include a data communication interface 460 for packet data communication. The platform may also include a central processing unit (“CPU”) 420, in the form of one or more processors, for executing program instructions. The platform may include an internal communication bus 410, and the platform may also include a program storage and/or a data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### 4. TERMINOLOGY

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of +10% in a stated value.

The term “exemplary” is used in the sense of “example” rather than “ideal.” As used herein, the singular forms “a,” “an,” and “the” include plural reference unless the context dictates otherwise.

### 5. EXAMPLES

Exemplary embodiments of the systems and methods disclosed herein are described in the numbered paragraphs below.

A1. A method for treating feed-, raw-, or wastewater, or other aqueous streams (“streams”) for select constituents while simultaneously recovering select desirable constituents from the streams, the method comprising: (i) providing a selective ion separation system (SISR) comprising a pair of electrodes, a catholyte compartment containing the cathode and aqueous electrolyte, an anolyte compartment containing the anode and aqueous electrolyte, and one or more multi-compartment cell “quartets,” in which each of the cell quartets includes: a first membrane (monovalent-selection cation exchange membrane or ion-specific cation exchange membrane), the first membrane being impermeable to a first aqueous ion and selectively permeable to a second aqueous ion, a second membrane (nonselective anion exchange membrane), the second membrane being selectively permeable to a third aqueous ion, a third membrane (monovalent-selection anion exchange membrane or ion-specific anion exchange membrane), the third membrane being selectively permeable to a fourth aqueous ion, a fourth membrane (bipolar ion exchange membrane), the fourth membrane being impermeable to ions in order to maintain a barrier between repeating units of membranes 1-3 when repeating units of the membrane quartets are utilized, at least four spacing frames, where each spacing frame comprises a structural element, a gasket, and a flow channel, wherein the membrane cell quartets are positioned between the catholyte and anolyte compartments, and the catholyte and anolyte compartments are each separated from the membrane quartet by means of a spacing frame and permselective cation exchange membrane; (ii) applying a voltage across said cathode and anode to transport select ions through compatible ion exchange membranes while flowing a feed-, raw-, or wastewater containing select undesirable constituents for treatment and/or select desirable constituents for recovery through the SISR system; (iii) using the membrane cell quartets and the applied voltage to produce at least four concentrated output streams, wherein each output stream comprises a higher level of the first aqueous ion, the second aqueous ion, the third aqueous ion, and the fourth first aqueous ion compared to the feed, raw, or wastewater.

A2. The method of A1, further comprising collecting one or more of the output streams for constituent recovery, reuse, and/or discharge.

A3. The method of any of A1-A2, further comprising utilizing the SISR system as pre-treatment to improve process efficiencies for downstream operations including reverse osmosis, super critical water oxidation, and other advanced treatment processes.

A4. The method of any of A1-A3, wherein the first membrane is a monovalent-selective cation exchange membrane, the second membrane is an anion exchange membrane, the third membrane is a monovalent-selective anion exchange membrane, and the fourth membrane is a bipolar ion exchange membrane, which is included when more than one cell quartet comprising membranes 1-3 are utilized.

A5. The method of any of A1-A4, wherein the first feed-, raw-, or wastewater, or aqueous stream constituents comprise monovalent cations including but not limited to ammonium, sodium, potassium, and hydrogen ions.

A6. The method of any of A1-A5, wherein the second feed-, raw-, or wastewater, or aqueous stream constituents comprise multivalent cations including but not limited to calcium, magnesium, and metal ions.

A7. The method of any of A1-A6, wherein the third feed-, raw-, or wastewater, or aqueous stream constituents comprise multivalent anions including but not limited to phosphate and sulfate.

A8. The method of any of A1-A7, wherein the fourth feed-, raw-, or wastewater, or aqueous stream constituents comprise monovalent anions including but not limited to hydroxide, chloride, or per- and polyfluoralkyl substances (PFAS) ions.

A9. The method of A4, wherein monovalent cation concentration in the first output stream is more than 30%, more than 20%, more than 15%, more than 10%, or more than 5% of monovalent anion concentration in the feed-, raw-, or wastewater, or other aqueous streams.

A10. The method of A5, wherein multivalent cation concentration in the first output stream is more than 90%, more than 80%, more than 70%, more than 60%, more than 50%, more than 40%, more than 30%, more than 20%, more than 15%, more than 10%, or more than 5% of multivalent cation concentration in the feed-, raw-, or wastewater, or other aqueous streams.

A11. The method of A6, wherein multivalent anion concentration in the first output stream is more than 90%, more than 80%, more than 70%, more than 60%, more than 50%, more than 40%, more than 30%, more than 20%, more than 15%, more than 10%, or more than 5% of multivalent anion concentration in the feed-, raw-, or wastewater, or other aqueous streams.

A12. The method of A7, wherein monovalent anion concentration in the first output stream is more than 90%, more than 80%, more than 70%, more than 60%, more than 50%, more than 40%, more than 30%, more than 20%, more than 15%, more than 10%, or more than 5% of monovalent anion concentration in the feed-, raw-, or wastewater, or other aqueous streams.

A13. The method of any of A1-A12, further comprising prioritizing the efficiency and productivity of the SISR system, wherein prioritizing efficiency and productivity entails flowing the feed water through the SISR system in a continuous, single flow-through pass.

A14. The method of any of A1-A13, further comprising increasing SISR system product concentration capacity by flowing feed-, raw-, or wastewater, or other aqueous streams into the SISR system in a batch process, wherein the at least four SISR separation products are returned to the at least four influent channels in recycle loop, and wherein the recycle loop is performed until the desired constituent concentration is reached.

A15. The method of any of A1-A14, further comprising removing foulant from the SISR system, wherein removing the foulant from the SISR system entails switching the polarity of the voltage.

A16. The method of A14, wherein switching the polarity of the voltage comprises repeatedly applying a forward bias voltage and then applying a reverse bias voltage, and wherein the forward bias voltage is applied for from 0.1 hours to 6 hours, then the reverse bias voltage is applied for from 0.1 minutes to 30 minutes.

A17. The method of A14, wherein ion separation performance of the first, second, or third membrane does not decrease by more than 60% after six months of use so long as the fouling mitigation strategy detailed in claim 14 is routinely employed.

A18. The method of any of A1-A17, further comprising mitigating foulant accumulation in the SISR system, wherein mitigating foulant accumulation in the SISR system entails pulsing the applied voltage across the cathode and anode.

A19. The method of A17, wherein pulsing the voltage comprises repeatedly applying a forward bias voltage and then applying no voltage (or, zero voltage), and wherein the forward bias voltage is applied for from 0.1 second to 5 minutes, then the zero voltage is applied for from 0.1 seconds to 5 minutes.

A20. The method of A17, wherein pulsing the voltage enables energy recovery during the no voltage condition, wherein the SISR system generates a voltage by passing an acidic solution on one side of the bipolar membrane and a basic solution on the opposite side of the bipolar membrane.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for treating feed-, raw-, or wastewater, or other aqueous streams (“streams”) for select constituents while simultaneously recovering select desirable constituents from the streams, the method comprising:
(i) providing a selective ion separation system (SISR) comprising a pair of electrodes, a catholyte compartment containing the cathode and aqueous electrolyte, an anolyte compartment containing the anode and aqueous electrolyte, and one or more multi-compartment cell “quartets,” in which each of the cell quartets includes:
a first membrane (monovalent-selection cation exchange membrane or ion-specific cation exchange membrane), the first membrane being impermeable to a first aqueous ion and selectively permeable to a second aqueous ion,
a second membrane (nonselective anion exchange membrane), the second membrane being selectively permeable to a third aqueous ion,
a third membrane (monovalent-selection anion exchange membrane or ion-specific anion exchange membrane), the third membrane being selectively permeable to a fourth aqueous ion,
a fourth membrane (bipolar ion exchange membrane), the fourth membrane being impermeable to ions in order to maintain a barrier between repeating units of membranes 1-3 when repeating units of the membrane quartets are utilized,
at least four spacing frames, where each spacing frame comprises a structural element, a gasket, and a flow channel,
wherein the membrane cell quartets are positioned between the catholyte and anolyte compartments, and the catholyte and anolyte compartments are each separated from the membrane quartet by means of a spacing frame and permselective cation exchange membrane;
(ii) applying a voltage across said cathode and anode to transport select ions through compatible ion exchange membranes while flowing a feed-, raw-, or wastewater containing select undesirable constituents for treatment and/or select desirable constituents for recovery through the SISR system;
(iii) using the membrane cell quartets and the applied voltage to produce at least four concentrated output streams, wherein each output stream comprises a higher level of the first aqueous ion, the second aqueous ion, the third aqueous ion, and the fourth first aqueous ion compared to the feed, raw, or wastewater.

2. The method of claim 1, further comprising collecting one or more of the output streams for constituent recovery, reuse, and/or discharge.

3. The method of claim 1, further comprising utilizing the SISR system as pre-treatment to improve process efficiencies for downstream operations including reverse osmosis, super critical water oxidation, and other advanced treatment processes.

4. The method of claim 1, wherein the first membrane is a monovalent-selective cation exchange membrane, the second membrane is an anion exchange membrane, the third membrane is a monovalent-selective anion exchange membrane, and the fourth membrane is a bipolar ion exchange membrane, which is included when more than one cell quartet comprising membranes 1-3 are utilized.

5. The method of claim 1, wherein the first feed-, raw-, or wastewater, or aqueous stream constituents comprise monovalent cations including but not limited to ammonium, sodium, potassium, and hydrogen ions.

6. The method of claim 1, wherein the second feed-, raw-, or wastewater, or aqueous stream constituents comprise multivalent cations including but not limited to calcium, magnesium, and metal ions.

7. The method of claim 1, wherein the third feed-, raw-, or wastewater, or aqueous stream constituents comprise multivalent anions including but not limited to phosphate and sulfate.

8. The method of claim 1, wherein the fourth feed-, raw-, or wastewater, or aqueous stream constituents comprise monovalent anions including but not limited to hydroxide, chloride, or per- and polyfluoralkyl substances (PFAS) ions.

9. The method of claim 4, wherein monovalent cation concentration in the first output stream is more than 90%, more than 80%, more than 70%, more than 60%, more than 50%, more than 40%, more than 30%, more than 20%, more than 15%, more than 10%, or more than 5% of monovalent anion concentration in the feed-, raw-, or wastewater, or other aqueous streams.

10. The method of claim 5, wherein multivalent cation concentration in the first output stream is more than 90%, more than 80%, more than 70%, more than 60%, more than 50%, more than 40%, more than 30%, more than 20%, more than 15%, more than 10%, or more than 5% of multivalent cation concentration in the feed-, raw-, or wastewater, or other aqueous streams.

11. The method of claim 6, wherein multivalent anion concentration in the first output stream is more than 90%, more than 80%, more than 70%, more than 60%, more than 50%, more than 40%, more than 30%, more than 20%, more than 15%, more than 10%, or more than 5% of multivalent anion concentration in the feed-, raw-, or wastewater, or other aqueous streams.

12. The method of claim 7, wherein monovalent anion concentration in the first output stream is more than 90%, more than 80%, more than 70%, more than 60%, more than 50%, more than 40%, more than 30%, more than 20%, more than 15%, more than 10%, or more than 5% of monovalent anion concentration in the feed-, raw-, or wastewater, or other aqueous streams.

13. The method of claim 1, further comprising prioritizing the efficiency and productivity of the SISR system, wherein prioritizing efficiency and productivity entails flowing the feed water through the SISR system in a continuous, single flow-through pass.

14. The method of claim 1, further comprising increasing SISR system product concentration capacity by flowing feed-, raw-, or wastewater, or other aqueous streams into the SISR system in a batch process, wherein the at least four SISR separation products are returned to the at least four influent channels in recycle loop, and wherein the recycle loop is performed until the desired constituent concentration is reached.

15. The method of claim 1 further comprising removing foulant from the SISR system, wherein removing the foulant from the SISR system entails switching the polarity of the voltage.

16. The method of claim 14, wherein switching the polarity of the voltage comprises repeatedly applying a forward bias voltage and then applying a reverse bias voltage, and wherein the forward bias voltage is applied for from 0.1 hours to 6 hours, then the reverse bias voltage is applied for from 0.1 minutes to 30 minutes.

17. The method of claim 14, wherein ion separation performance of the first, second, or third membrane does not decrease by more than 60% after six months of use so long as the fouling mitigation strategy detailed in claim 14 is routinely employed.

18. The method of claim 1 further comprising mitigating foulant accumulation in the SISR system, wherein mitigating foulant accumulation in the SISR system entails pulsing the applied voltage across the cathode and anode.

19. The method of claim 17, wherein pulsing the voltage comprises repeatedly applying a forward bias voltage and then applying no voltage (or, zero voltage), and wherein the forward bias voltage is applied for from 0.1 second to 5 minutes, then the zero voltage is applied for from 0.1 seconds to 5 minutes.

20. The method of claim 17, wherein pulsing the voltage enables energy recovery during the no voltage condition, wherein the SISR system generates a voltage by passing an acidic solution on one side of the bipolar membrane and a basic solution on the opposite side of the bipolar membrane.
